(19) United States
(12) Patent Application Publication
(10) Pub. No.: US 2013/0024882 A1
(43) Pub. Date: Jan. 24, 2013

(54) ELECTRONIC DEVICE AND SOCIAL COMMERCE SERVER FOR PERFORMING COUPON SEARCH

(71) Applicants: Kyechul LEE, Seoul (KR); Duksung KIM, Seoul (KR); Sunghyuk PARK, Seoul (KR); Junwon LIM, Seoul (KR); Mikyoung JUNG, Seoul (KR); Hyekyeong YEOM, Seoul (KR)

(72) Inventors: Kyechul LEE, Seoul (KR); Duksung KIM, Seoul (KR); Sunghyuk PARK, Seoul (KR); Junwon LIM, Seoul (KR); Mikyoung JUNG, Seoul (KR); Hyekyeong YEOM, Seoul (KR)

(73) Assignee: LG ELECTRONICS INC., Seoul (KR)

(21) Appl. No.: 13/280,435

(22) Filed: Oct. 25, 2011

Related U.S. Application Data
(63) Continuation of application No. PCT/KR2011/005387, filed on Jul. 21, 2011.

(51) Int. Cl. G06Q 30/02; H04N 21/80

(52) U.S. Cl. 725/23; 705/14.54

(57) ABSTRACT

Disclosed is an electronic device. The electronic device may include a communication unit and a control unit. The communication unit may provide access to at least one network. The control unit extracts a search keyword from contents received through the communication unit, searches for a coupon for at least one product corresponding to the search keyword in a social commerce network, and transmits a result of the coupon search to another predetermined electronic device.

The present application claims priority to Korean Application No. PCT/KR2011/005387 filed in Korea on Jul. 21, 2011, the entire contents of which are hereby incorporated by reference in their entirety.

### BACKGROUND

1. Field

The present invention relates to an electronic device and a social commerce server, and more particularly, to an electronic device and a social commerce server capable of performing coupon search on the basis of a search factor extracted from contents.

2. Related Art

The functional diversification of electronic devices such as smart TVs, personal computers, notebook computers, cellular phone, smart phones, and the like has lead to the implementation of electronic devices in the form of multimedia players having multiple functions including a camera function of capturing pictures or videos, a music or video player function, a game function, a broadcasting receiver function, and the like. In order to support and enhance the functions of electronic devices, improving terminals structurally and/or in terms of software may be considered.

### SUMMARY

Accordingly, one object of the present invention is to address the above-noted and other drawbacks of the related art.

Another object of the present invention is to provide an electronic device capable of extracting a search keyword from received contents, searching for a coupon by using the extracted search keyword, and sharing a result of the coupon search with another electronic device.

Still another object of the present invention is to provide an electronic device capable of searching for a coupon by extracting a search factor from output contents according to the kind of the contents being output, or searching for a coupon on the basis of information regarding contents which are to be output after the contents being currently output.

Another object of the present invention is to provide an electronic device capable of using a couple selected among searched coupons to order a product corresponding to the selected coupon, or of transmitting the selected coupon to another electronic device.

Still another object of the present invention is to provide a social commerce server capable of performing coupon search in response to a coupon search request for a single electronic device when receiving coupon search requests from a plurality of electronic devices provided with the same contents, and transmitting a result of the coupon search to the plurality of electronic devices including the single electronic device.

To accomplish the objects of the present invention, according to an aspect of the present invention, there is provided an electronic device including: a communication unit providing a communication function with the outside; and a control unit extracting a search keyword from received contents through the communication unit, accessing a social commerce network to search for a coupon for a product corresponding to the search keyword, and transmitting a result of coupon search to another electronic device.

To accomplish the objects of the present invention, according to another aspect of the present invention, there is provided an electronic device including: a communication unit receiving contents; an output unit outputting the received contents; and a control unit performing coupon search by extracting a search factor from the contents currently being output or performing coupon search on the basis of information regarding a different type of contents which are to be output after the contents currently being output, according to a type of the contents currently being output.

To accomplish the objects of the present invention, according to another aspect of the present invention, there is provided an electronic device including: a display; a communication unit performing a communication function with an external node; and a control unit extracting a search factor from contents received through the communication unit to thus perform coupon search, and displaying a coupon list of searched coupons on the display, wherein when a specific coupon is selected from the coupon list, the control unit displays on the display a user interface for performing at least one of ordering a product corresponding to the specific coupon with the specific coupon applied thereto, and transmission of the specific coupon to another electronic device.

To accomplish the objects of the present invention, according to another aspect of the present invention, there is provided a social commerce server including: a communication unit receiving requests for coupon search from a plurality of electronic devices receiving the same contents; and a control unit performing coupon search in response to only a request for coupon search received from one of the plurality of electronic devices, and transmitting the result of coupon search to all of the plurality of electronic devices through the communication unit.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating an electronic device according to the present invention;

FIG. 2 is a view illustrating the configuration of a social commerce system including an electronic device according to an embodiment of the present invention;

FIG. 3 is a flowchart illustrating a coupon search method of an electronic device according to an embodiment of the present invention;

FIG. 4 is a flowchart illustrating one example of the coupon search method of the electronic device shown in FIG. 3;

FIG. 5 illustrates one example of the process of extracting a search keyword for coupon search according to the coupon search method of the electronic device shown in FIG. 4;

FIG. 6 illustrates one example of the process of searching for a coupon with respect to a specific search keyword according to the coupon search method of the electronic device shown in FIG. 4;

FIG. 7 is a flowchart illustrating another example of the coupon search method of the electronic device shown in FIG. 3;

FIG. 8 illustrates one example of the process of searching for a coupon according to the coupon search method of the electronic device shown in FIG. 7;

FIG. 9 is a flowchart illustrating one example of a method in which an electronic device shares a result of the coupon search with another electronic device in a coupon search method of the electronic device according to the present invention;

FIG. 10 illustrates one example of transmitting a result of coupon search to another electronic device according to the method of sharing a search result shown in FIG. 9;

FIG. 11 is a flowchart illustrating another example of the coupon search method of the electronic device shown in FIG. 3;

FIG. 12 illustrates one example of the process of searching for a coupon according to the coupon search method of the electronic device shown in FIG. 11;

FIG. 13 is a flowchart illustrating one example of the coupon search method of the electronic device shown in FIG. 3;

FIG. 14 illustrates one example of the process of searching for a coupon according to the coupon search method of the electronic device shown in FIG. 13;

FIG. 15 is a flowchart illustrating another example of the coupon search method of the electronic device shown in FIG. 3;

FIGS. 16 through 18 illustrate a series of processes of performing the coupon search method shown in FIG. 15;

FIGS. 19A and 19B illustrates that coupons searched for by performing the coupon search method of FIG. 15 a plurality of times are categorized according to a predetermined reference and stores in a memory;

FIG. 20 is a flowchart illustrating another example of a coupon search method of an electronic device according to the present invention;

FIGS. 21 through 23 illustrate the process of transmitting a result of coupon search to a mobile terminal according to the coupon search method shown in FIG. 20;

FIG. 24 illustrates the process of setting a zone for which a coupon is searched for on the basis of a search keyword extracted from contents in an electronic device according to the present invention;

FIG. 25 is a flowchart illustrating another example of a coupon search method of an electronic device according to the present invention;

FIG. 26 illustrates one example of coupon search performed according to the coupon search method shown in FIG. 25;

FIG. 27 is a flowchart illustrating another example of a coupon search method of an electronic device according to the present invention;

FIGS. 28 through 30 illustrate examples of coupon search performed according to the coupon search method shown in FIG. 27;

FIG. 31 is a block diagram illustrating a social commerce server according to the present invention;

FIG. 32 is a flowchart illustrating one example of a coupon search method performed in a social commerce server according to the present invention; and

FIGS. 33 through 34 illustrate the process of performing the coupon search method shown in FIG. 32.

### DETAILED DESCRIPTION OF THE PREFERRED EMBODIMENTS

This document will now be described more fully with reference to the accompanying drawings, in which exemplary embodiments of this document are shown. This document may, however, be embodied in many different forms and should not be construed as being limited to the embodiments set forth herein; rather, there embodiments are provided so that this disclosure will be thorough and complete, and will fully convey the concept of this document to those skilled in the art.

Hereinafter, a mobile terminal relating to this document will be described below in more detail with reference to the accompanying drawings. In the following description, suffixes “module” and “unit” are given to components of the mobile terminal in consideration of only facilitation of description and do not have meanings or functions discriminated from each other.

The mobile terminal described in the specification can include a cellular phone, a smart phone, a laptop computer, a digital broadcasting terminal, personal digital assistants (PDA), a portable multimedia player (PMP), a navigation system and so on.

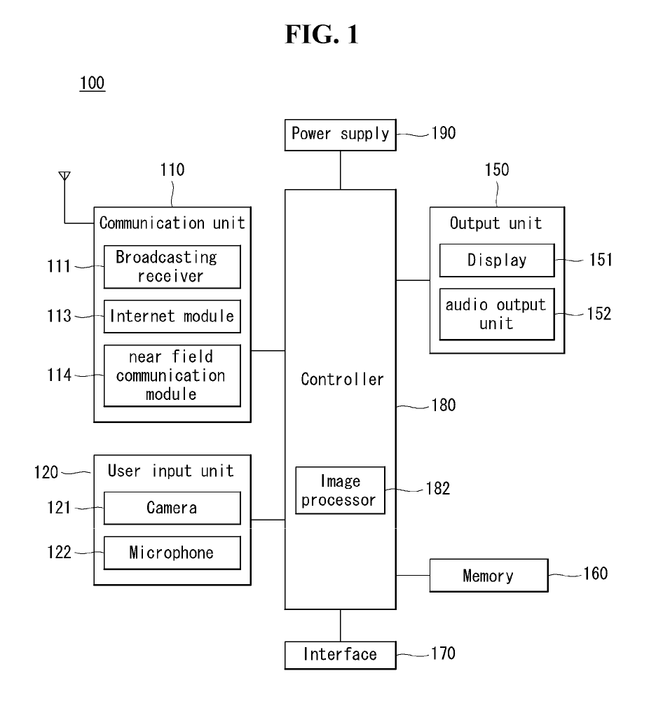

FIG. 1 is a block diagram of a display device relating to an embodiment of this document.

As shown, the display device 100 may include a communication unit 110, a user input unit 120, an output unit 150, a memory 160, an interface 170, a controller 180, and a power supply 190. Not all of the components shown in FIG. 1 may be essential parts and the number of components included in the display device 100 may be varied.

The communication unit 110 may include at least one module that enables communication between the display device 100 and a communication system or between the display device 100 and another device. For example, the communication unit 110 may include a broadcasting receiving module 111, an Internet module 113, and a short range communication module 114.

The broadcasting receiving module 111 may receive broadcasting signals and/or broadcasting related information from an external broadcasting management server through a broadcasting channel.

The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal. The broadcasting signals may include not only TV broadcasting signals, radio broadcasting signals, and data broadcasting signals but also signals in the form of a combination of a TV broadcasting signal and a radio broadcasting signal of a data broadcasting signal.

The broadcasting related information may be information on a broadcasting channel, a broadcasting program or a broadcasting service provider, and may be provided even through a communication network.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 111 may receive broadcasting signals using various broadcasting systems. The broadcasting signals and/or broadcasting related information received through the broadcasting receiving module 111 may be stored in the memory 160.

The Internet module 113 may correspond to a module for Internet access and may be included in the display device 100 or may be externally attached to the display device 100.

The short range communication module 114 may correspond to a module for near field communication. Further, Bluetooth, radio frequency identification (RFID), infrared data association (IrDA), ultra wideband (UWB) and/or ZigBee may be used as a near field communication technique.

The user input 120 is used to input an audio signal or a video signal and may include a camera 121 and a microphone 122.

The camera 121 may process image frames of still images or moving images obtained by an image sensor in a video telephony mode or a photographing mode. The processed image frames may be displayed on a display 151. The camera 121 may be a 2D or 3D camera. In addition, the camera 121 may be configured in the form of a single 2D or 3D camera or in the form of a combination of the 2D and 3D cameras.

The image frames processed by the camera 121 may be stored in the memory 160 or may be transmitted to an external device through the communication unit 110. The display device 100 may include at least two cameras 121.

The microphone 122 may receive an external audio signal in a call mode, a recording mode or a speech recognition mode and process the received audio signal into electric audio data. The microphone 122 may employ various noise removal algorithms for removing or reducing noise generated when the external audio signal is received.

The output unit 150 may include the display 151 and an audio output module 152.

The display 151 may display information processed by the display device 100. The display 151 may display a user interface (UI) or a graphic user interface (GUI) relating to the display device 100. In addition, the display 151 may include at least one of a liquid crystal display, a thin film transistor liquid crystal display, an organic light-emitting diode display, a flexible display and a three-dimensional display. Some of these displays may be of a transparent type or a light transmissive type. That is, the display 151 may include a transparent display. The transparent display may include a transparent liquid crystal display. The rear structure of the display 151 may also be of a light transmissive type. Accordingly, a user may see an object located behind the body of terminal through the transparent area of the terminal body, occupied by the display 151.

The display device 100 may include at least two displays 151. For example, the display device 100 may include a plurality of displays 151 that are arranged on a single face at a predetermined distance or integrated displays. The plurality of displays 151 may also be arranged on different sides.

Further, when the display 151 and a sensor sensing touch (hereafter referred to as a touch sensor) form a layered structure that is referred to as a touch screen, the display 151 may be used as an input device in addition to an output device. The touch sensor may be in the form of a touch film, a touch sheet, and a touch pad, for example.

The touch sensor may convert a variation in pressure applied to a specific portion of the display 151 or a variation in capacitance generated at a specific portion of the display 151 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 can detect a touched portion of the display 151.

The audio output module 152 may output audio data received from the communication unit 110 or stored in the memory 160. The audio output module 152 may output audio signals related to functions, such as a call signal incoming tone and a message incoming tone, performed in the display device 100.

The memory 160 may store a program for operation of the controller 180 and temporarily store input/output data such as a phone book, messages, still images, and/or moving images. The memory 160 may also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk or an optical disk. The display device 100 may also operate in relation to a web storage performing the storing function of the memory 160 on the Internet.

The interface 170 may serve as a path to all external devices connected to the display device 100. The interface 170 may receive data from the external devices or power and transmit the data or power to internal components of the display device terminal 100 or transmit data of the display device 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The controller 180 may control overall operations of the display device 100. For example, the controller 180 may perform control and processing for voice communication. The controller 180 may also include an image processor 182 for pressing image, which will be explained later.

The power supply 190 receives external power and internal power and provides power required for each of the components of the display device 100 to operate under the control of the controller 180.

Various embodiments described in this document can be implemented in software, hardware or a computer readable recording medium. According to hardware implementation, embodiments of this document may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. The embodiments may be implemented by the controller 180 in some cases.

According to software implementation, embodiments such as procedures or functions may be implemented with a separate software module executing at least one function or operation. Software codes may be implemented according to a software application written in an appropriate software language. The software codes may be stored in the memory 160 and executed by the controller 180.

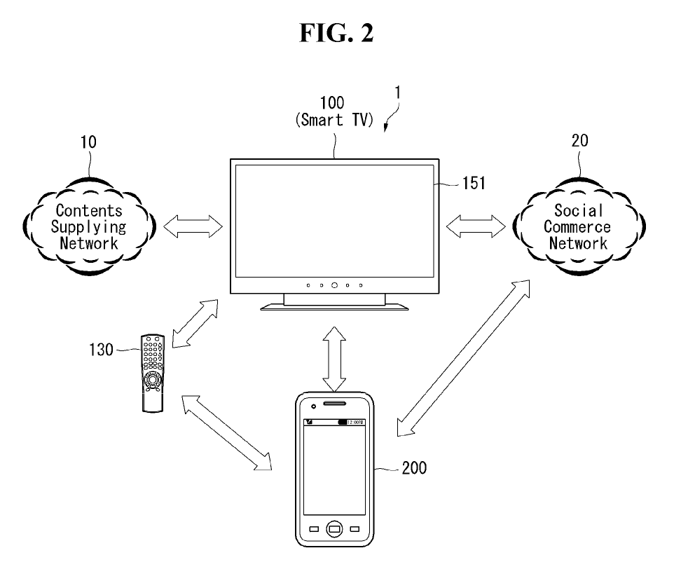

FIG. 2 is a view illustrating the configuration of a social commerce system including the electronic device 100 according to an embodiment of the present invention. Referring to FIG. 2, a social commerce system 1 includes a contents provision network 10, a social commerce network 20, the electronic device 100 according to the present invention, the remote controller 130 of the electronic device 100, and another electronic device 200.

The electronic device 100 may receive various contents from the contents provision network 10 through the communication unit 110, and output the received contents through the output unit 150. As shown in FIG. 2, the electronic device 100 may be implemented as a smart TV which may be connected to an external network. A control signal for performing general functions provided by the electronic device 100 and performing coupon search by using the electronic device 100 may be generated by manipulating the remote controller 130.

Meanwhile, contents received from the contents provision network 10 may include a video such as a broadcasting program, a commercial film, or the like, a still image, a web page image, or the like, but the present invention is not limited thereto.

When contents are received from the contents provision network, the electronic device 100 acquires information for searching for a coupon, provided by the social commerce network 20, from the received contents, and may search for a coupon from the social commerce network 20 by using the acquired information.

The social commerce network 20 may include a server storing product information or searching for product information b using information for the coupon search, a server storing or searching for coupons for various products, a server for selling various products, and the like.

The electronic device 100 receives a result of the coupon search (hereinafter, a coupon search result) from the social commerce network 20, and may store the received result in the memory 160. The coupon search result may include a searched coupon, and information used in receiving the searched coupon from the social commerce network 20.

When the coupon search result is received, the electronic device 100 may output the coupon search result through the output unit 150. In more detail, the control unit 180 of the electronic device 100 may display the result of the coupon search on the display 151 or output the result through the audio output module 152.

Then, a user of the electronic device 100 may recognize the coupon search result output through the output unit 150, and select a search result with respect to a specific coupon from the coupon search result. Then, the electronic device 100 may transmit information associated with the specific coupon to another electronic device 200 connected to a short range communication network formed by the communication unit 110, thus sharing the information. Referring to FIG. 2, another electronic device 200 is implemented as a mobile terminal but the present invention is not limited thereto.

Furthermore, the coupon search result transmitted to another electronic device 200 may be set to be deleted by another electronic device 200 when the term of validity of the searched coupon expires. For example, the electronic device 100 may send another electronic device 200 a delete command that is set to be executed when the term of validity of the searched coupon expires, together with the coupon search result.

According to an implementation example of the present invention, the electronic device 100 may control the social commerce network 20 such that the social commerce network 20 transmits the coupon search result to another electronic device 200. In this case, the electronic device 100 need to send the social commerce network 20 not only information required for coupon search but also information regarding another electronic device 200.

According to another implementation example of the present invention, the electronic device 100 may transmit the coupon search result to the remote controller 130, and the remote controller 130 may store the coupon search result. Thereafter, the remote controller 130 may transmit the coupon search result to another electronic device 200 in response to a request from another electronic device 200.

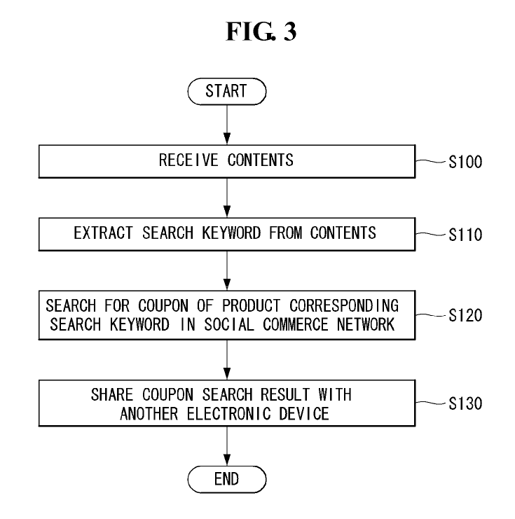

FIG. 3 is a flowchart illustrating a coupon search method of the electronic device 100 according to an embodiment of the present invention. Hereinafter, the coupon search method will be described with reference to accompanying drawings.

First, the electronic device 100 receives contents through the communication unit 110 from the contents provision network 10 in operation S100. When the contents are received, the control unit 180 of the electronic device 100 extracts a search keyword from the received contents in operation S110. Here, the search keyword may be included as separate metal data in the received contents, or may be extracted from a video signal or an audio signal of the received contents. Also, the control unit 180 may extract the search keyword by analyzing the received contents. Alternatively, the control unit 180 may request the social commerce network 20 to extract a search keyword by transmitting a portion of the video or audio signal to the social commerce network 20, and then receive the extracted search keyword from the social commerce network 20.

When the search keyword is extracted, the control unit 180 searches for a coupon of a product corresponding to the search keyword in operation S120. The searching for the coupon of a product corresponding to the search keyword may include searching for a product corresponding to the search keyword, and searching for a coupon corresponding to the searched product. Here, a product corresponding to the search keyword and a coupon associated with the searched product may be searched for by the social commerce network 20 upon request of the control unit 180.

When the searching for the product corresponding to the search keyword is completed, the control unit 180 shares the coupon search result with another electronic device in operation S130. As described above with reference to FIG. 2, the coupon search result may be received by the electronic device 100 and then transmitted to another electronic device 200, or may be directly transmitted to another electronic device 200 from the social commerce network 20.

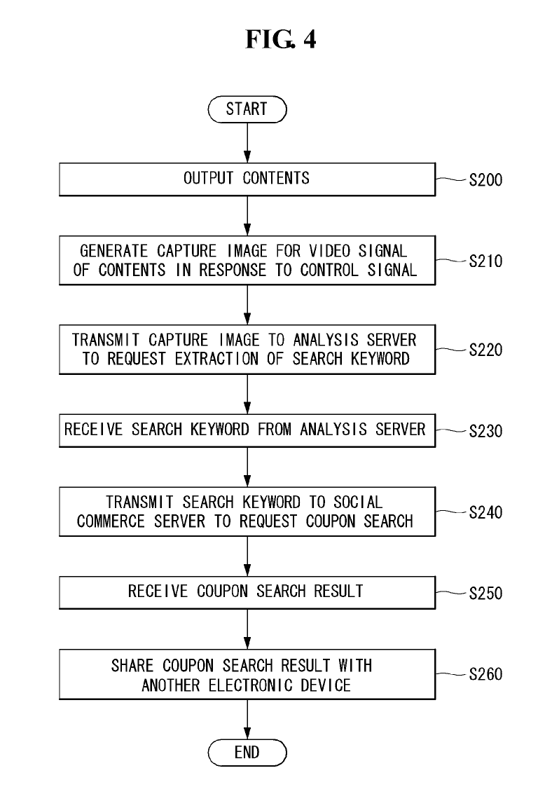

FIG. 4 is a flowchart illustrating one example of the coupon search method of the electronic device 100 shown in FIG. 3.

The control unit 180 of the electronic device 100 outputs received contents through the output unit 150 in operation S200. For example, a video signal of the contents is output through the display 151 of the output unit 150, and an audio signal of the contents may be output through the audio output module 152 of the output unit 150.

When a control signal is received while the contents are being output, the control unit 180 generates a capture image of a video signal output through the display 151 in response to the control signal in operation S210. Here, the control signal may be generated on the basis of the manipulation of a user with respect to the remote controller 130 of the electronic device 100.

When the capture image is generated, the control unit 180 requests the extraction of a search keyword by transmitting the capture image to an analysis server in operation S220. Thereafter, the electronic device 100 receives the extracted search keyword from the analysis server through the communication unit 110 in operation S230. Here, the analysis server may be a server which is in charge of extracting a search keyword in the social commerce network 20. As shown in FIG. 4, the extraction of a search keyword based on the capture image may be performed by image analysis in the control unit 180.

When the search keyword is received, the control unit 180 requests coupon search by transmitting the search keyword to a social commerce server in operation S240. The social commerce server searches for a coupon for a product corresponding to the search keyword. Here, the social commerce server may be a server which is in charge of storage and search for coupons for various products in the social commerce network 20.

Thereafter, the electronic device 100 receives the coupon search result from the social commerce server through the communication unit 110 in operation S250, and shares the received coupon search result with another electronic device in operation S260. Although not shown in the drawing, the control unit 180 may provide a user with the coupon search result through the display 151 and the audio output module 152 of the output unit 150.

In the coupon search method shown in FIG. 4, if the contents are a TV commercial, the user of the electronic device 100 may search for a coupon when he wants while watching TV, and may store the searched coupon in another electronic device such as a mobile terminal.

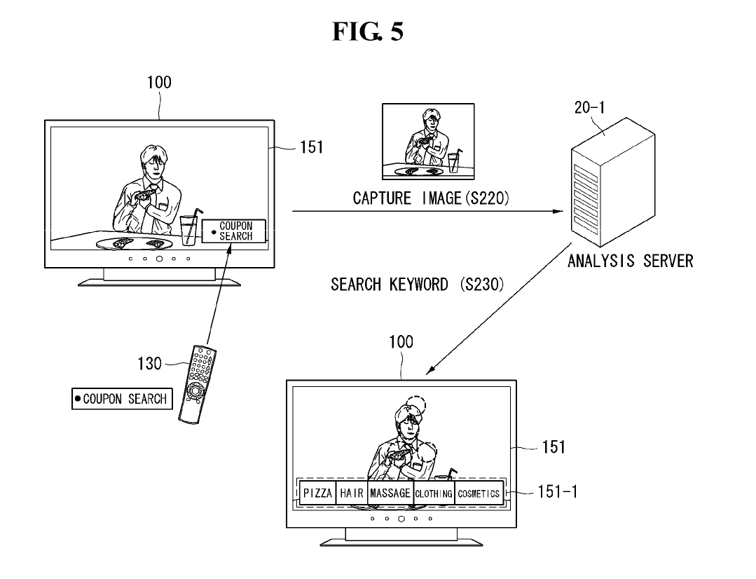

FIG. 5 illustrates one example of the process of extracting a search keyword for coupon search in the coupon search method of the electronic device 100 shown in FIG. 4. Hereinafter, the process will be described with reference to accompanying drawings.

While the TV commercial is being output through the electronic device 100, the user generates a control signal by manipulating a coupon search button of the remote controller 130. Then, the control unit 180 of the electronic device 100 generates a capture image of the TV commercial in response to the control signal, and then transmits the capture image to an analysis server 20-1 in operation S220.

The analysis server 20-1 having received the capture image extracts a text (i.e., a search keyword) from the capture image and transmits the extracted test to the electronic device 100 in operation S230. Then, the electronic device 10 receives the search keyword and displays the received search keyword on the display 151. Referring to FIG. 5, as for the search keyword received in the electronic device 100, there may be a plurality of search keywords such as pizza, hair, massage, clothing, cosmetics corresponding to regions indicated by dotted lines in the capture image.

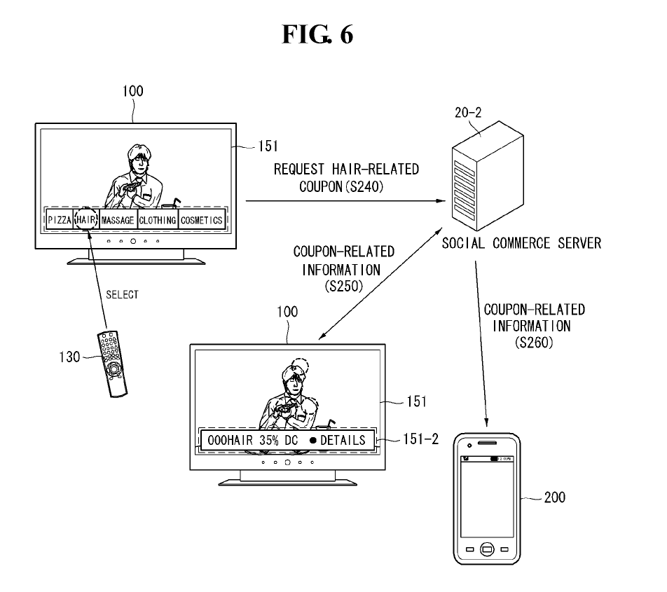

FIG. 6 illustrates one example of the process of searching for a coupon associated with a specific search keyword according to the coupon search method of the electronic device 100 shown in FIG. 4.

In the state where the search keywords are displayed on the display 151 of the electronic device 100 according to the process shown in FIG. 5, the user selects ‘hair’ among the search keywords displayed on the display 151 by manipulating the remote controller 130 of the electronic device 100.

Then, the control unit 180 of the electronic device 100 requests a social commerce server 20-2 to search for a coupon associated to the selected search keyword ‘hair’ in operation S240, and the social commerce server 20-2 searches for a coupon corresponding to ‘hair’ from among pre-stored coupons.

Thereafter, the social commerce server 20-2 transmits information regarding the searched hair-related coupon to the electronic device 100 in operation S250. Then, the electronic device 100 may display details 151-2 regarding the searched hair-related coupon on the display 151. The user selects the coupon-related information to thereby download the air-related coupon from the social commerce server 20-2. Unlike FIG. 6, the social commerce server 20-2 may transmit the search coupon itself to the electronic device 100.

Also, the social commerce server 20-2 may directly transmit information regarding the searched hair-related coupon (hereinafter, also referred to as “coupon-related information) to another electronic device 200 in operation S260. The operation S260 shown in FIG. 5 may be performed when the control unit 180 previously makes a request to directly transmit the coupon-related information to another electronic device 200. When the coupon-related information is received, another electronic device 200 may provide a user with the coupon-related information. Then, the user selects the coupon-related information to thereby download a coupon corresponding to the coupon-related information from the social commerce server 20-2. Unlike FIG. 6, the social commerce server 20-2 may transmit a coupon itself to another electronic device 200.

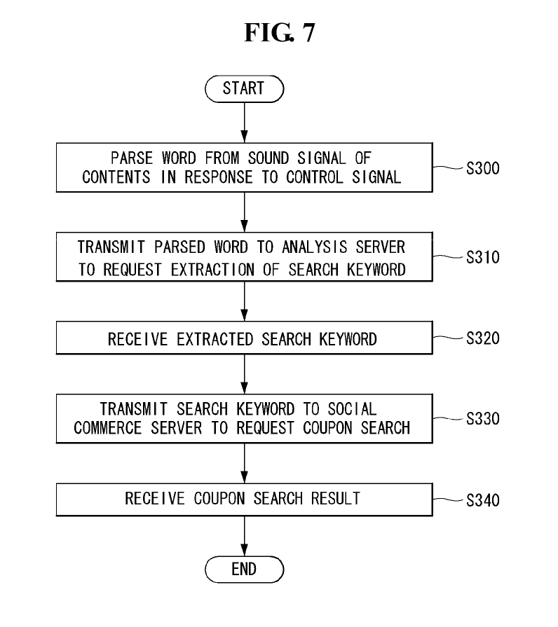

FIG. 7 is a flowchart illustrating one example of the coupon search method of the electronic device 100 shown in FIG. 3.

When a control signal is received while the contents are being output, the control unit 180 of the electronic device 100 parses a word from an audio signal of the contents in response to the control signal in operation S300. Here, the control signal may be generated on the basis of the manipulation of the user with respect to the remote controller 130 of the electronic device 100.

Thereafter, the control unit 180 makes a request to extract a search keyword by transmitting the parsed word to an analysis server in operation S310. Thereafter, the electronic device 100 receives the extracted search keyword from the analysis server through the communication unit 110 in operation S320. Unlike FIG. 7, the extraction of the search keyword based on the parsed word may be performed by the control unit 180.

When the search keyword is received, the control unit 180 requests coupon search by transmitting the search keyword to a social commerce server in operation S330. The electronic device 100 receives a coupon search result from the social commerce server through the communication unit 110 in operation S340.

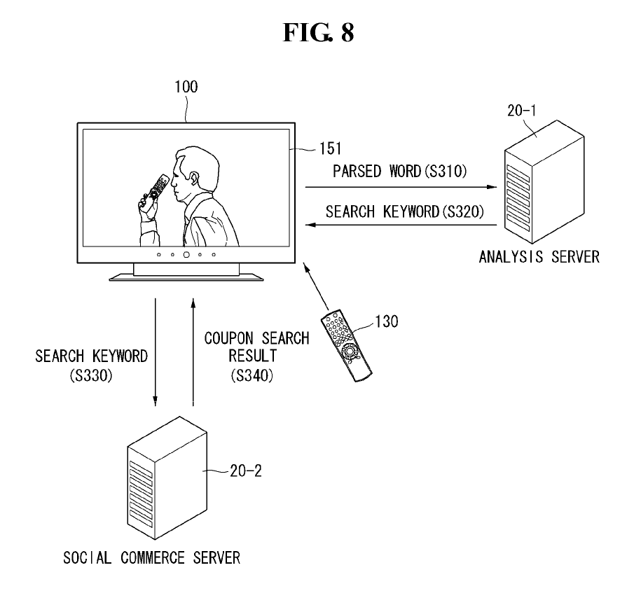

FIG. 8 illustrates one example of the process of searching for a coupon according to the coupon search method of the electronic device 100 shown in FIG. 7.

While the contents are being output, a control signal is generated on the basis of the manipulation of the user with respect to the electronic device 100. Then, the control unit 180 of the electronic device 100 extracts a sentence from an audio signal of the contents and then parses the extracted sentence in the units of words. Thereafter, the control unit 180 transmits the parsed word to an analysis server 20-1 to thus make a request for the extraction of a search keyword in operation S310.

Thereafter, the electronic device 100 receives the extracted search keyword on the basis of the parsed word from the analysis server 20-1 in operation S320, and transmits the search keyword to a social commerce server 20-2 to thus make a request for coupon search for a product corresponding to the search keyword in operation S330.

Thereafter, the electronic device 100 receives a coupon search result from the social commerce server 20-2 in operation S340. As described above, the coupon search result may be a searched coupon itself, or information used in acquiring the searched coupon. Also, the coupon search result may be directly transmitted to another electronic device.

The search-keyword extraction process of the analysis server 20-1 will now be described in more detail. The analysis server 20-1 may extract the search keyword by comparing the parsed word with product information configured in the form of thesaurus.

Here, the thesaurus is a kind of index (software) for performing mechanical search for information, which is the main job of a computer. The Thesaurus defines and standardize the meaning of each term to thus promote the unification of concept in search, and allows anyone to search for the same contents in the same order. Product information configured in the form of thesaurus may be product information categorized in synonym, homonym, broad-term, narrow-term, and thesaurus items.

In the thesaurus form, words like TV, television, smart TV, IP TV and the like may be synonyms, words like pail, pale (noun), and pale (adj.) may be homonyms, words like small and big may be antonyms, words like electronic device and TV may be in narrow- and broad-term relationship, and words like TV and home theater may be thesauruses.

The process in which the analysis server 20-1 compares a parsed word with pre-stored product information configured in the form of thesaurus to thus extract a search keyword may be performed by the following rules:

(1) A word in the pre-stored product information, corresponding to a homonym or an antonym is excluded.

(2) A word in the pre-stored product information, which is a synonym of the parsed word has the highest priority.

(3) If a word matching to the parsed word is not searched for in the pre-stored product information during the above comparison process, a word in the pre-stored product information, which is in broad- and narrow-term relationship with the parsed word or which is a thesaurus of the parsed word is extracted as a search keyword.

The above rules for the extraction of a search keyword are merely one example of the search-keyword extraction process performed in the analysis server 20-1, and the present invention is not limited thereto.

The process of extracting a search keyword according to a result of the comparison between the parsed word and the product information stored in the form of thesaurus may be performed by the control unit 180 of the electronic device 100. In this case, the product information configured in the form of thesaurus may be stored in advance in the memory 160 of the electronic device 100.

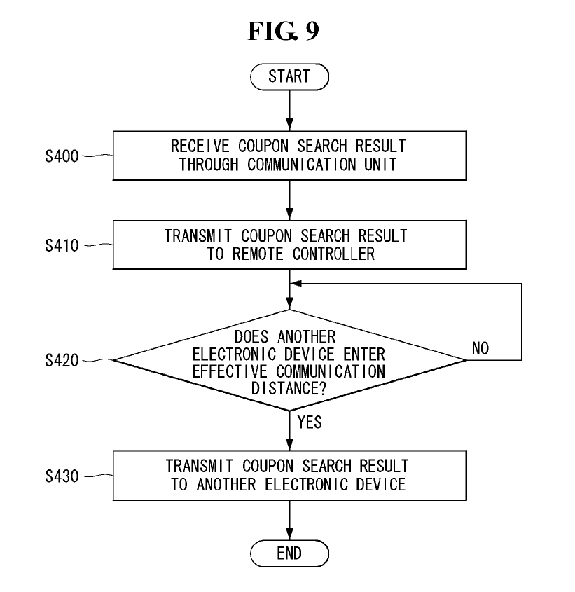

FIG. 9 is a flowchart illustrating one example of a method in which the electronic device 100 shares a coupon search result with another electronic device in a coupon search method of the electronic device 100 according to the present invention.

First, the electronic device 100 receives a coupon search result from the social commerce network 20 through the communication unit 110 in operation S400. Thereafter, the electronic device 100 transmits the coupon search result to the remote controller 130 of the electronic device 100 in operation S410.

The remote controller 130 stores received coupon search result in a predetermined storage space, and then checks whether or not another electronic device 200 enters an effective communication distance of a short range wireless communication network by the remote controller 130 in operation S420.

When another electronic device 200 enters an effective communication distance of the short range wireless communication network, the remote controller 130 transmits the stored coupon search result to another electronic device 200 in operation S430. Here, the coupon search result may be a searched coupon itself. Also, the coupon search result may be a Uniform Resource Locator (URL) that can download a searched coupon. Then, a user of another electronic device 200 may access the social commerce network 20 by using the URL and then download the searched coupon.

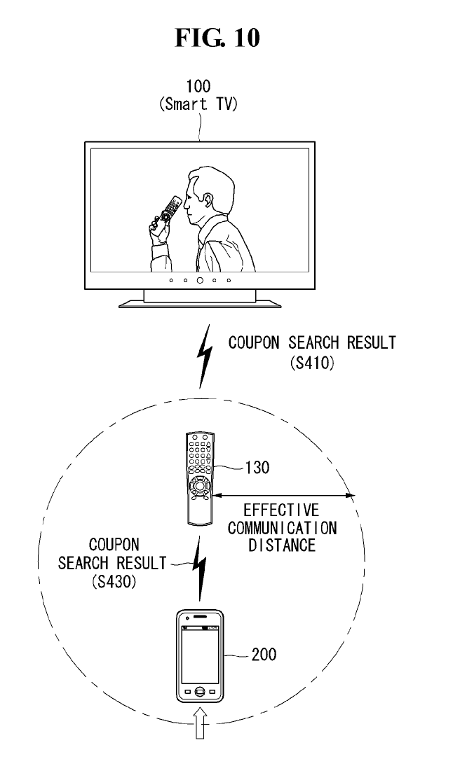

FIG. 10 illustrates one example of transmitting a coupon search result to another electronic device 200 according to the method of sharing a search result shown in FIG. 9. Referring to FIG. 10, the electronic device 100 according to the present invention may be implemented as a smart TV, and another electronic device 200 may be implemented as a mobile terminal. However, the present invention is not limited thereto.

The smart TV 200 transmits a coupon search result to the remote controller 130 in operation S410. Then, the remote controller 130 stores the received coupon search result in a predetermined storage space. Thereafter, when the mobile terminal 200 enters an effective communication distance of a short range wireless communication network which may be formed by the remote controller 130, the remote controller 130 transmits the stored coupon search result to the mobile terminal 200.

If each of the remote controller 130 and the mobile terminal 200 includes an NFC module and the short range wireless communication network is an NFC wireless communication network, a user of the mobile terminal 200 tags the mobile terminal 20 to the remote controller 130, so that the coupon search result can be stored in the mobile terminal 200.

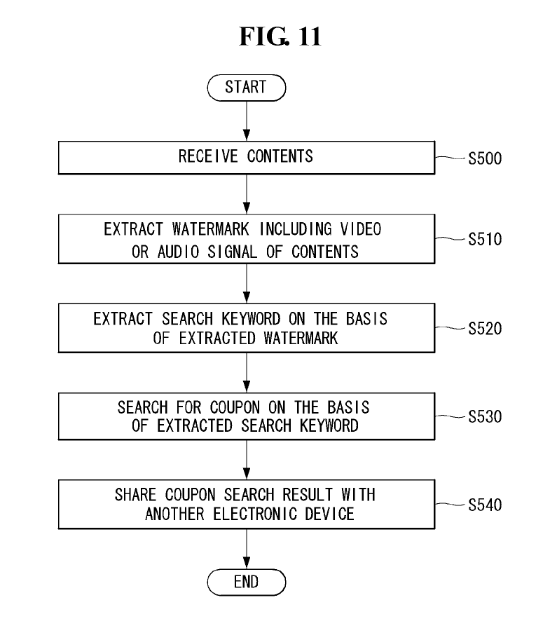

FIG. 11 is a flowchart illustrating another example of a coupon search method of an electronic device according to the present invention. Hereinafter, the coupon search method will be described with reference to accompanying drawings.

First, contents are received through the communication unit 110 in operation S500. When contents are received, the control unit 180 of the electronic device 100 extracts a watermark included in a video or audio signal of the contents in operation S520. Herein, the watermark refers to a technique for inserting in digital contents a code such as an ID or information that only predetermined electronic devices or predetermined users can recognize, or inserting a specific code or specific data in a video or audio signal. In FIG. 11, the watermark refers to data included in the contents in order to extract a search keyword for coupon search.

When the watermark is extracted from the contents, the control unit 180 extracts a search keyword on the basis of the watermark in operation S520. Here, the control unit 180 may extract a search keyword on the basis of a watermark extracted by itself, or may make a request for the extraction of a search keyword by transmitting the extracted watermark to the social commerce network 20.

When a search keyword is extracted on the basis of the watermark, the control unit 180 performs coupon search on the basis of the extracted search keyword in operation S530. As described above, the coupon search based on the search keyword may be performed by the social commerce server 20-2.

When the coupon search is completed, the control unit 180 shares the coupon search result with another electronic device in operation S540. For example, the control unit 180 may receive the coupon search result from the social commerce network 20, and then transmit the received coupon search result to another electronic device. Also, the control unit 180 may control the social commerce server 20-2 so as to directly transmit the coupon search result to another electronic device.

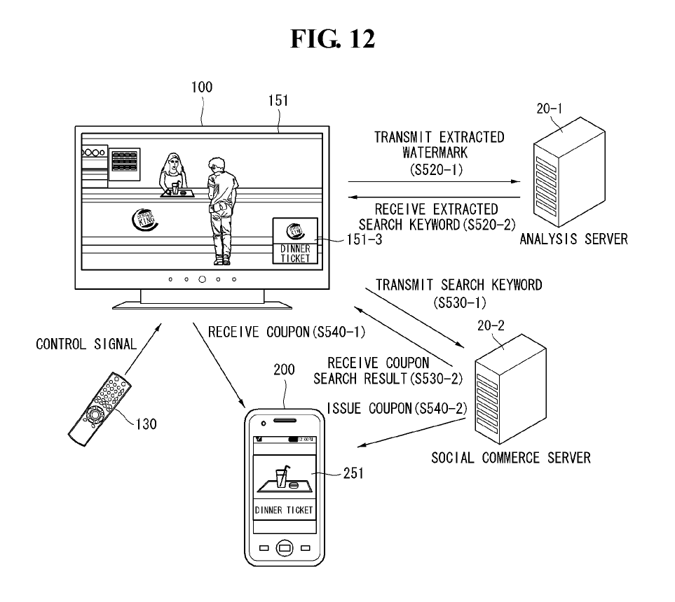

FIG. 12 illustrates one example of the process of searching for a coupon according to the coupon search method of the electronic device, shown in FIG. 11.

First, a smart TV 100, an electronic device according to the present invention, receives a commercial, received contents, and outputs a video signal of the received commercial through the display 151. The control unit 180 of the smart TV 100 extracts a watermark included in the video signal of the commercial, and sends the extracted watermark to an analysis server 20-1 in operation S520-1. Thereafter, the electronic device 100 receives a search keyword extracted on the basis of the watermark from the analysis server 20-1 in operation S520-2. Unlike FIG. 12, the extraction of a keyword based on the extracted watermark may be performed by the control unit 180.

When the extracted search keyword is received, the control unit 180 transmits the search keyword to a social commerce server 20-2 to thus request coupon search for a product corresponding to the search keyword in operation S530-1. Thereafter, the electronic device 100 receives a coupling search result based on the transmitted search keyword from the social commerce server 20-2 in operation S530-2.

When the coupon search is completed, the control unit 180 may share the coupon search result with the mobile terminal 200. As shown in FIG. 12, the control unit 180 may transmit a coupon, received from the social commerce server 20-2, to the mobile terminal 200 in operation S540-1, and may control the social commerce server 20-2 to issue a coupon to the mobile terminal 200 in operation S540-2.

As shown in FIG. 12, a user may generate a control signal for controlling the smart TV 100 to display information indicating whether or not coupon can be issued by the commercial, by manipulating the remote controller 130. When the control signal is received from the remote controller 130, the control unit 180 may display image 151-3 indicating whether or not a coupon can be issued by the commercial as shown in FIG. 12.

Furthermore, the user may generate a control signal for controlling the smart TV 100 to perform the coupon search, by manipulating the remote controller 130. Also, by manipulating the remote controller 130, the user may generate a control signal for controlling the smart TV 100 to receive a coupon search result from the social commerce server 20-2.

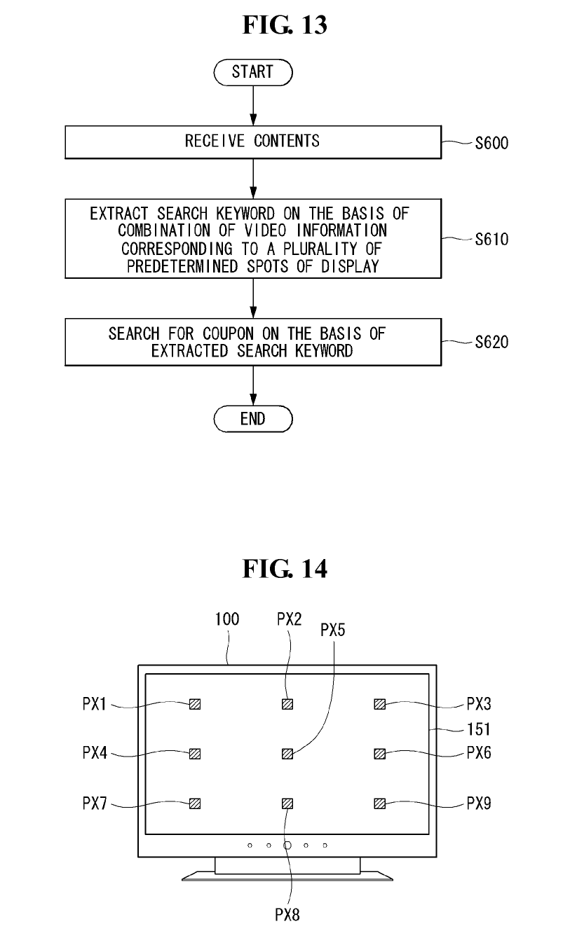

FIG. 13 is a flowchart illustrating one example of the coupon search method of an electronic device shown in FIG. 13. Hereinafter, the coupon search method will be described with reference to accompanying drawings.

First, contents are received through the communication unit 110 in operation S600. The control unit 180 of the electronic device 100 extracts video information corresponding to a plurality of predetermined spots of the display 151 outputting a video signal of the contents. Herein, the video information may include brightness information of pixels, luminous information, color information and the like corresponding to the predetermined spots, but the present invention is not limited to. Also, the predetermined spots may be small in terms of number or wide in terms of intervals therebetween such that a user does not feel awkward about an image being output through the display 151.

When video information corresponding to the plurality of predetermined spots is extracted, the control unit 180 extracts a search keyword on the basis of combination of the extracted video information in operation S610. When the search keyword is extracted, the control unit 180 performs coupon search on the basis of the search keyword in operation S620. The process of receiving a result of coupon search performed after the completion of the coupon search and the process of sending the coupon search result to another electronic device are the same as or similar to the above embodiments. Therefore, a description of such processes will be omitted.

FIG. 14 illustrates one example of setting a plurality of spots on the display 151 of a phase rotation indicating electronic device 100 according to the coupon search method of the electronic device 100 shown in FIG. 13. Referring to FIG. 14, video information corresponding to nine pixels PX1 to PX9 on the display 151 is used to extract the search keyword.

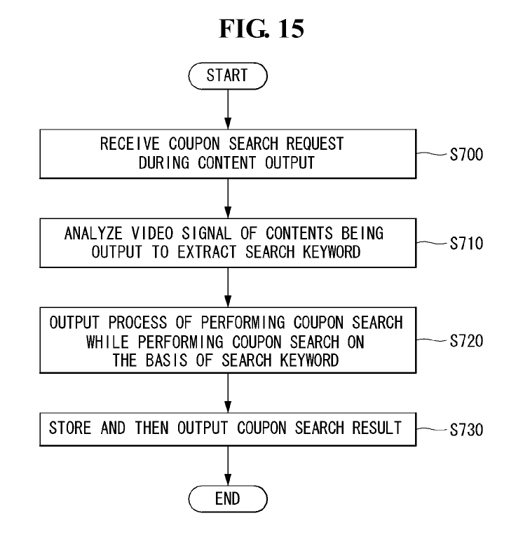

FIG. 15 is a flowchart illustrating another example of the coupon search method of the electronic device 100 shown in FIG. 3.

The electronic device 100, while outputting received contents through the output unit 150, receives a result for coupon search in operation S700. Then, the control unit 180 of the electronic device 100 analysis video signal of the contents being output and thus extracts a search keyword in operation S710. The control unit 180 may perform its own analysis of a video signal.

Also, the control unit 180 receives a request for coupon search and then transmits a capture image of the video signal to the social commerce network 20 to thus request the extraction of a search keyword. Meanwhile, there may be a plurality of search keywords extracted as a result of the analysis of the video signal.

When the search keyword is extracted, the control unit 180 outputs the process of performing coupon search through the output unit 150 while searching for a coupon on the basis of the extracted search keyword in operation S720. When a coupon is searched for, the control unit 180 may store in the memory 160 a coupon search result including information associated with the searched coupon, and then output the stored coupon search result through the output unit 150.

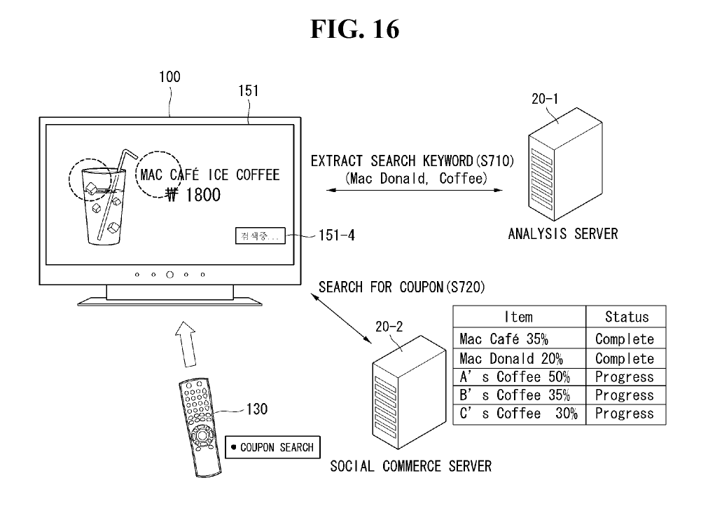

FIGS. 16 through 18 illustrate a series of processes of the coupon search method shown in FIG. 15.

Referring to FIG. 16, while the smart TV 100, which is an electronic device according to the present invention, outputs a coffee commercial, a coupon search request generated based on the remote controller 130 of a user is received in operation S130. When the coupon search request is received, the control unit 180 of the smart TV 100 outputs through the display 151 information 151-4 indicating that coupon search is in progress. Although not shown in the drawing, the control unit 180 may output information indicating the coupon search is in progress through the audio output module 152.

When the coupon search request is received, the control unit 180 requests an analysis server 20-1 to extract a search keyword through analysis of a video signal of the contents currently being output. In this case, the control unit 180 may generate a capture image of the video signal and transit the capture image to the analysis server 20-1.

When the analysis server 20-1 completes the process of extracting the search keyword, the smart TV 100 receives search keywords ‘Mac Donald’ and ‘Coffee’ from the analysis server 20-1 in operation S710. When the search keywords are received, the control unit 180 requests a social commerce server 20-2 to search for a coupon of a product corresponding to the search keywords, and receives a result of the coupon search in operation S720.

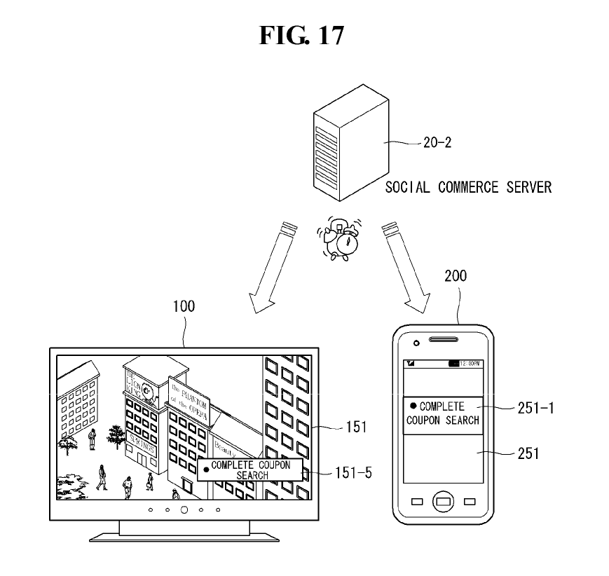

Referring to FIG. 17, when the coupon search is completed, the social commerce server 20-2 informs the smart TV 100 or a mobile terminal 200, which is another predetermined electronic device, of the completion of the coupon search. Then, the smart TV 100 displays information 151-5 indicating the completion of the coupon search on the display 151, and the mobile terminal 20 also displays information 251-1 indicating the completion of the coupon search on a display 251 thereof.

In this case, it can be seen that contents output through the display 151 are changed to a commercial for another product from the coffee commercial. That is, when a request for coupon search is received, the control unit 180 performs the coupon search in the background while continuously outputting contents.

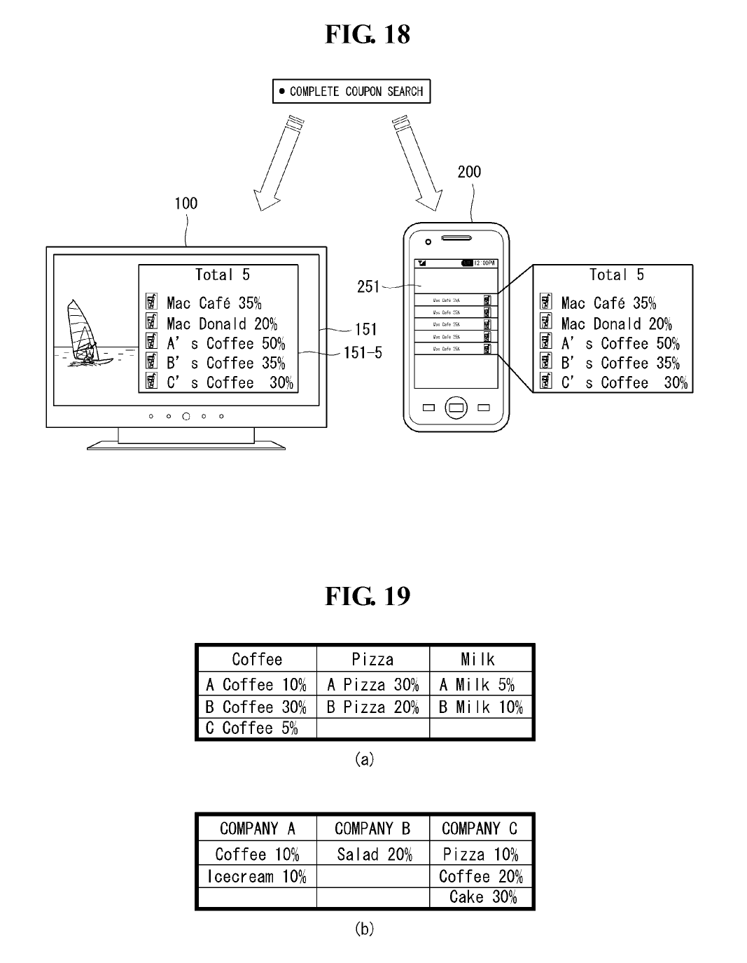

Referring to FIG. 18, when the coupon search is completed, the social commerce server 20-2 transmits a coupon search result to the smart TV 100 and the mobile terminal 200. Then, the smart TV 100 and the mobile terminal 200 receive and store the coupon search result, and display the coupon search result on the display 151 or 251 upon request or automatically.

If the coupon search process according to the coupon search method depicted in FIGS. 15 through 18 is performed a plurality of times, the smart TV 100 or the mobile terminal 200 may manage results of coupon search performed a plurality of times by classifying them according to a predetermined reference.

FIGS. 19A and 19B illustrate that coupons searched for by performing the coupon search method of FIG. 15 a plurality of times are categorized according to a predetermined reference and stores in a memory

Referring to FIG. 19A, a plurality of coupons searched for as a result of multiple coupon search requests may be categorized according to kinds of products and stored in the memory 160. Referring to FIG. 19B, the plurality of searched coupons may be categorized according to types of companies that have issued those coupons and stored in the memory 160.

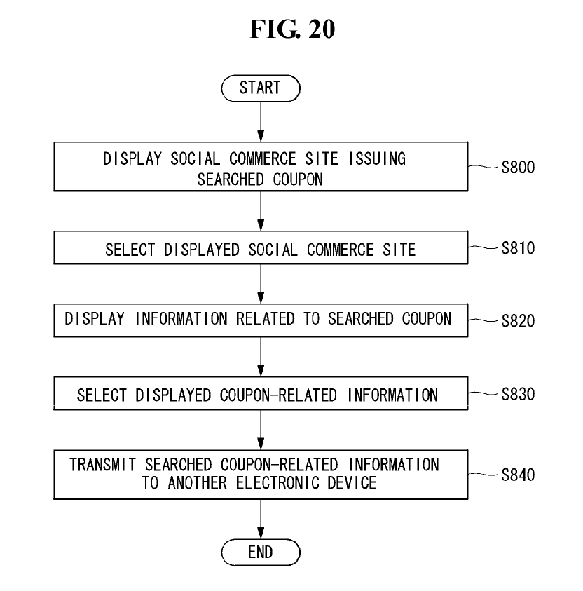

FIG. 20 is a flowchart illustrating another example of a coupon search method of the electronic device 100 according to the present invention.

The control unit 180 of the electronic device 100 displays a social commerce site issuing a searched coupon, which is a result of coupon search, on the display 151 in operation S800. In this case, a user selects the social commerce site displayed on the display 151 in operation S810. Then, the control unit 180 display information associated with the searched coupon on the display 151.

In the state where the information associated with the searched coupon is displayed on the display 151, if the user selects the information associated with the searched coupon in operation S830, the control unit 180 transmits the information associated with the searched coupon to another electronic device in operation S840. Here, the information associated with the searched coupon may be the searched coupon itself, which is stored in the memory 160 of the electronic device 100. Furthermore, according to another implementation example of the present invention, the information associated with the searched coupon may be link information regarding the searched coupon.

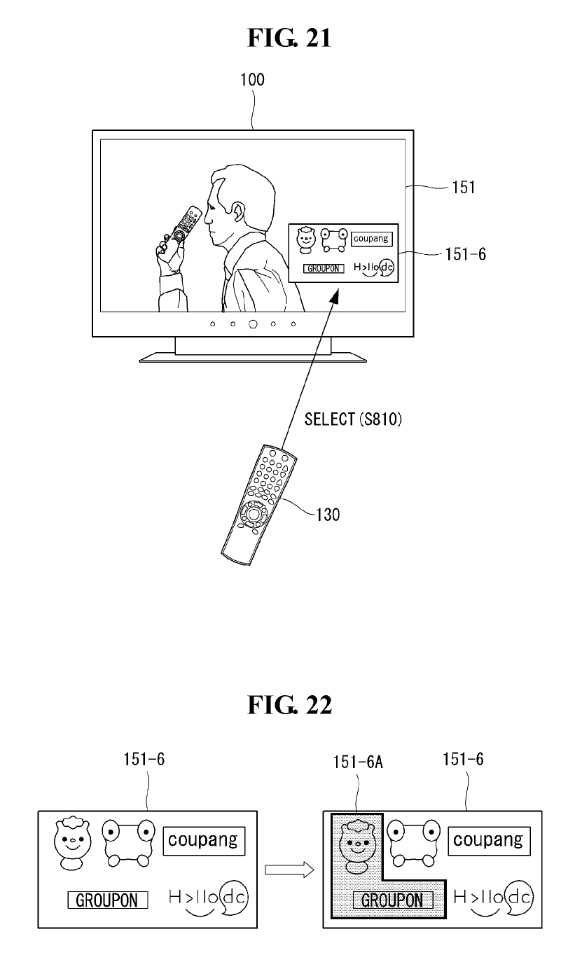

FIGS. 21 through 23 illustrate the process of transmitting a coupon search result to the mobile terminal 200 according to the coupon search method shown in FIG. 20.

In FIG. 21, while a smart TV 100, which is an electronic device according to the present invention, is outputting contents, the control unit 180 of the smart TV 100 displays social commerce sites 151-6 issuing searched coupons on the display 151. FIG. 22 illustrates that in a case where a coupon is searched for only in one social commerce site 151-6A among a plurality of predetermined social commerce sites 151-6, the one social commerce site 151-6A may be displayed differently from other social commerce sites.

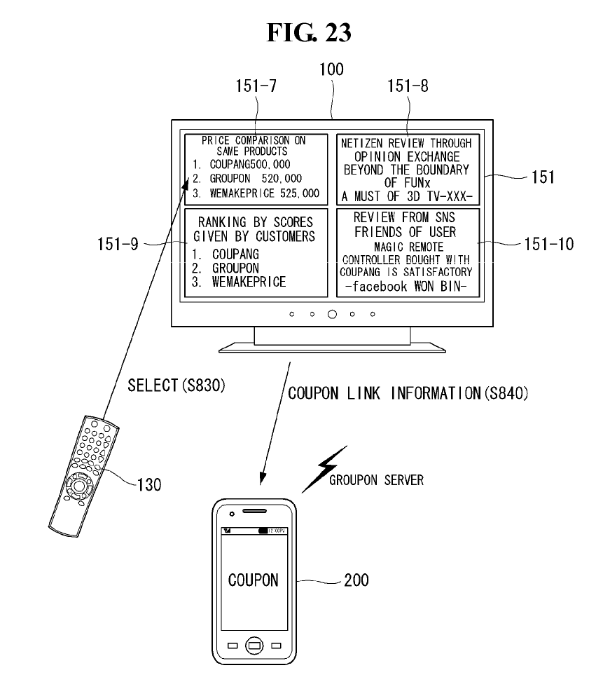

In the state of FIG. 21, the user selects a display region 151-6 of the social commerce sites by manipulating the remote controller 130 in operation S810. Then, as shown in FIG. 23, the control unit 180 displays on the display 151 information 151-7 associated to a plurality of coupons searched for in the plurality of social commerce sites, netizen reviews 151-8 about products, scores 151-9 determined by customers for products, reviews 151-10 received from acquaintances of users, and the like in operation S820. In the state of FIG. 23, when the user selects coupon-related information regarding social commerce site ‘GROUPON’ by manipulating the remote controller 130 in operation S830, the control unit 180 transmits link information regarding the selected coupon to the mobile terminal in operation S840. Then, the user of the mobile terminal 20 may download the coupon from a GROUPON server by using the received link information and use the coupon.

In the above, the method of searching for a coupon in the social commerce network 20 on the basis of a search keyword extracted from received contents without regional limitations has been described so far. However, the electronic device 100 may search for a coupon by using the search keyword for only a predetermined specific region.

This means that the electronic device 100 may search for a coupon in the state where a region in which the coupon is available is defined in advance. The specific region may be determined in advance by a user. For example, a user may make a request for coupon search after determining a region in which the user is to use a searched coupon. Here, the specific region may include a specific administrative section or a section within a predetermined radius from a specific spot designated by the user. However, the present invention is not limited thereto.

Also, the specific region may be determined in advance on the basis of the location of the electronic device 100. For example, the specific region may be an administrative section in which the electronic device 100 is located, or a region within a predetermined radius from the location of the electronic device 100. However, the present invention is not limited thereto.

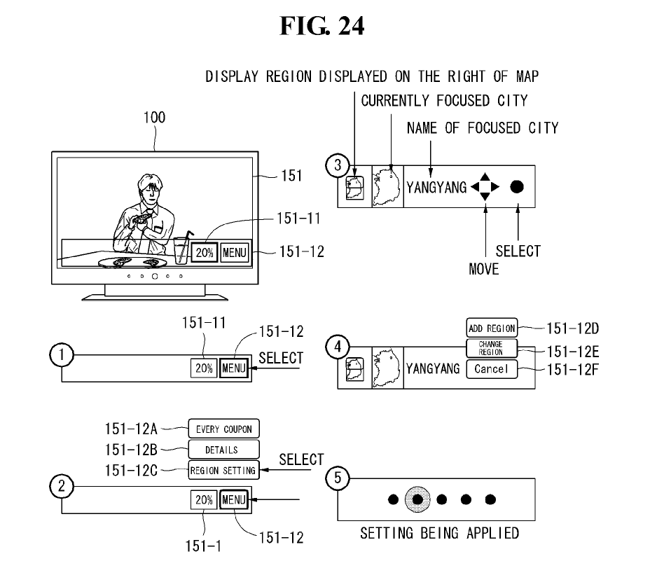

FIG. 24 illustrates the process in which the electronic device 100 according to the present invention sets a region for which a coupon is to be searched for (hereinafter, also referred to as a coupon search region) on the basis of a search keyword extracted from contents. Hereinafter, the process of setting a coupon search region will be sequentially described with reference to FIG. 24.

Referring to FIG. 24, the smart TV 100, which is an electronic device according to the present invention, outputs a commercial through the display 151, and the display 151 displays coupon information 151-11 corresponding to the commercial and a memory 151-12. In this case, the user selects the menu 151-12. Then, the control unit 180 of the smart TV 100 displays lower menus including a menu 151-12A for displaying every coupon, a menu 151-12B for displaying details of the menu, and a menu 151-12c for setting a coupon search region.

In the state where a plurality of lower menus are displayed, the user selects the region setting menu from among the lower menus. Then, the control unit 180 displays on the display 151 a user interface allowing the user to set a region for coupon search. Referring to FIG. 24, the user interface may include an overall map which is displayed such that a region to be enlarged is displayed to be visually distinguishable from other regions, a predetermined region displayed enlarged and including a currently focused city, a name of the currently focused city, a region for movement and selection on the map, and the like.

Referring to FIG. 24, the user selects city ‘YangYang’ by using the user interface, and selects a region change menu 151-12E among the lower menus provided in the region setting menu. Then, the control unit 180 sets ‘YangYang’ as the coupon search region.

As shown in FIG. 24, since the electronic device according to the present invention supports the user to set the coupon search region by using a map, the user may view the overall outline of a selectable region in the process of setting the coupon search region, and can have improved readability. Furthermore, since the user interface is displayed on a portion of the display 151, the user can set the coupon search region while watching contents.

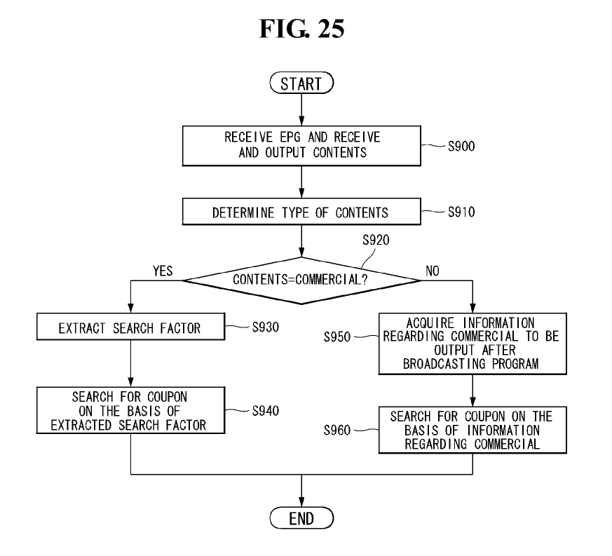

FIG. 25 is a flowchart illustrating another example of a coupon search method of the electronic device 100 according to the present invention.

The electronic device 100 receives an electronic program guide (EPG) and contents through the communication unit 110, and outputs the received contents through the output unit 150 in operation S900, and determines the kind of contents being output on the basis of the received EPG in operation S920.

When the contents being output is a commercial in operation S920, the control unit 180 of the electronic device 100 extracts a search factor from the contents being output in operation S930. Here, the search factor may include a search keyword output from the output contents, a capture image of a video signal of the output contents, a parsed work from an audio signal of the output contents, and the like. However, the present invention is not limited thereto.

When the search factor is extracted from the output contents, the control unit 180 performs coupon search on the basis of the search factor in operation S940. Since the process of performing coupon search on the basis of the search factor may be identical or similar to the coupon search process described in the above embodiments, a detailed description thereof is omitted.

If the contents being output is a broadcasting program in operation S920, the control unit 180 acquires information associated with a commercial which is to be output after the broadcasting program on the basis of the received EPG in operation S950, and subsequently, performs coupon search on the basis of the information regarding the acquired commercial in operation S960. Herein, the information associated with a commercial may include information regarding an advertiser, information regarding a target product, the time for the commercial, and the like. However, the present invention is not limited thereto.

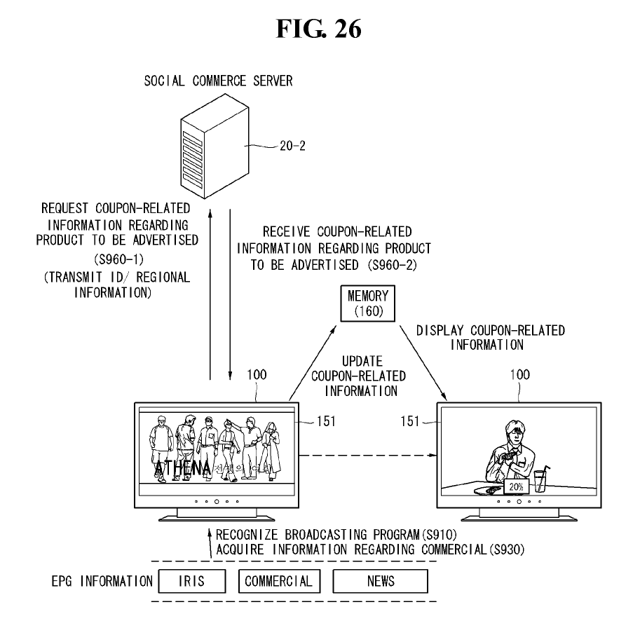

FIG. 26 illustrates one example of coupon search performed according to the coupon search method shown in FIG. 25.

First, the control unit 180 of the electronic device 100 recognizes that contents currently being output are a broadcasting program on the basis of EPG information in operation S910. Thereafter, the control unit 180 acquires information regarding a commercial which is to be output through the output unit 150 after the broadcasting program in operation S930.

Thereafter, the control unit 180 requests a social commerce server 20-2 for coupon-related information regarding a product to be advertized, which is information regarding the commercial, in operation S960-1. In this case, the control unit 180 may also transmit an ID allocated to the electronic device 100 and regional information. On the basis of the ID and the regional information, the coupon search region may be defined.

When the social commerce server 20-2 completes the search for the coupon-related information, the electronic device 100 receives the coupon-related information regarding the product to be advertised in operation S960-2, and updates coupon-related information stored in the memory 160 with the received coupon-related information regarding to the product to be advertised.

When the output of the broadcasting program is completed, the control unit 180 outputs a commercial through the display 151. At this time, the control unit 180 outputs to the display 151 the coupon-related information regarding the product to be advertized and stored in memory 160, together with the commercial.

As described with reference to FIGS. 25 and 26, the electronic device 100 according to the present invention may perform coupon search by extracting a search factor from the contents being output according to the type of contents being output, or may perform coupon search by using information regarding another type of contents which are to be output after the contents currently being output. In this case, the information regarding the types of contents may be acquired by additional contents information such as an EPG.

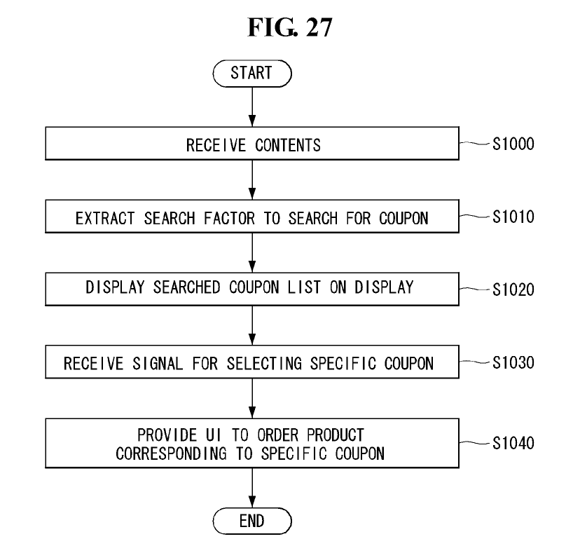

FIG. 27 is a flowchart illustrating another example of a coupon search method of the electronic device 100 according to the present invention.

The electronic device 100 receives contents through the communication unit 110 in operation S1000, and performs coupon search by extracting a search factor from the received contents in operation S1010. In this case, the control unit 180 may perform coupon search for a predetermined specific region. For example, the specific region may be determined in advance on the basis of location information of the electronic device 100 or determined in advance by the user.

When the coupon search is completed, the control unit 180 of the electronic device 100 displays a searched coupon list on the display 151 in operation S1020. Thereafter, the electronic device 100 receives a signal for selecting a specific coupon from the coupon list through the communication unit 110 in operation S1030. When the specific coupon is selected, the control unit 180 provides on the display 151 a user with a user interface allowing the user to order a product corresponding to the specific coupon by using the specific coupon in operation S1040.

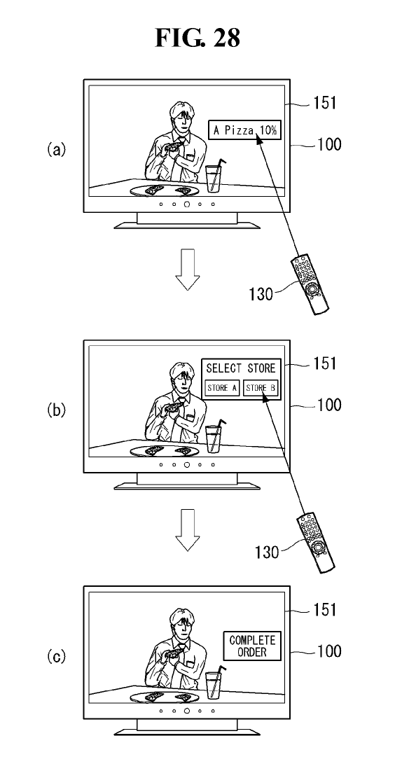

FIGS. 28A through 28C illustrate examples of coupon search performed according to the coupon search method of FIG. 27.

FIGS. 28A through 28C illustrate the process in which a user selects a discount coupon for specific pizza displayed on the display 151 and orders the specific pizza.

Referring to FIG. 28A, in the state where a pizza commercial and a coupon for the pizza being advertised are displayed on the display 151 of the smart TV 100, namely, an electronic device according to the present invention, a user selects a discount coupon for the pizza by manipulating the remote controller 130.

Then, as shown in FIG. 28B, the control unit 180 of the smart TV 100 applies the coupon to the pizza and displays stores to order the pizza. The stores may be located within a predetermined radius from the smart TV 100, may be located within a region predetermined by the user, or may be designated in advance by the user.

Referring to FIG. 28B, the user manipulates the remote controller 130 to thus select a region in order to order the pizza from store B. Then, as shown in FIG. 28C, the control unit 180 orders the pizza through the communication unit 151 and outputs to the display 151 a message indicating that the order has been successfully made to the display 151.

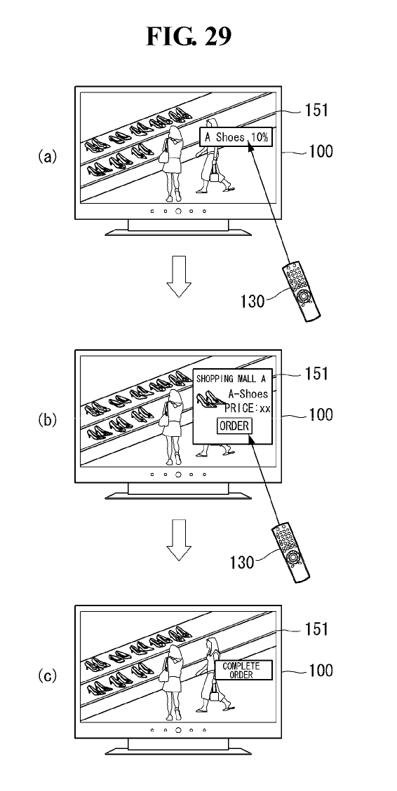

FIGS. 29A through 29C illustrate the process in which the user selects a discount coupon for specific shoes displayed in the display 151 and orders the specific shoes.

Referring to FIG. 29A, in the state where the display 151 of the smart TV 100, which is an electronic device according to the present invention, displays a shoes commercial and a coupon for the shoes being advertised, the user selects a discount coupon for the shoes by manipulating the remote controller 130.

Then, as shown in FIG. 29B, the control unit 180 of the smart TV 100 displays on the display 151 a homepage of a shopping mall to order the shoes by applying the coupon for the shoes thereto.

Referring to FIG. 29B, the user selects a region for ordering the shoes by manipulating the remote controller 130. Then, as shown in FIG. 29C, the control unit 180 orders the shoes through the communication unit 110 and outputs on the display 151 a message indicating the order has been successfully made.

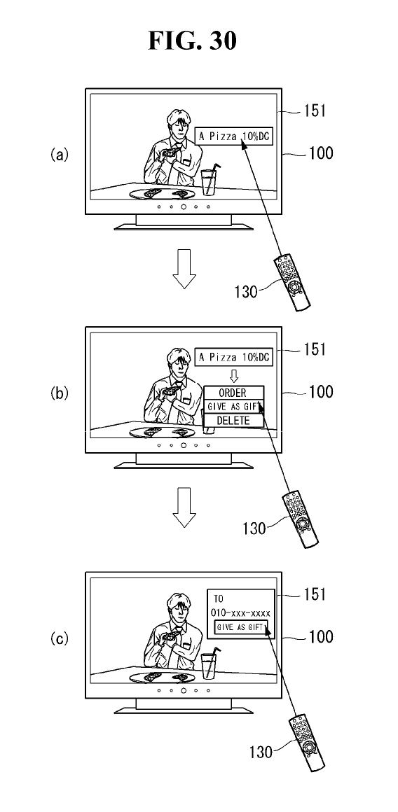

FIGS. 30A through 30C illustrate the process in which the user selects a discount coupon for specific pizza displayed on the display 151 and gives a specific person the coupon as a gift.

Referring to FIG. 30A, in the state where the display 151 of the smart TV 100, which is an electronic device according to the present invention, displays a pizza commercial and a coupon for pizza being advertised, the user selects a discount coupon for the pizza by manipulating the remote controller 130.

Then, as shown in FIG. 30B, the control unit 180 of the smart TV 100 displays a user interface allowing the user to order the pizza by applying the coupon to the order, to delete the coupon for the pizza, or to give another person the coupon for the pizza as a gift.

Referring to FIG. 30B, the user manipulates the remote controller 130 to thus select a region for giving the coupon for the pizza as a present. Then, as shown in FIG. 30C, the control unit 180 displays on the display 151 a user interface allowing the user to transmit the coupon for the pizza to a mobile terminal of another person.

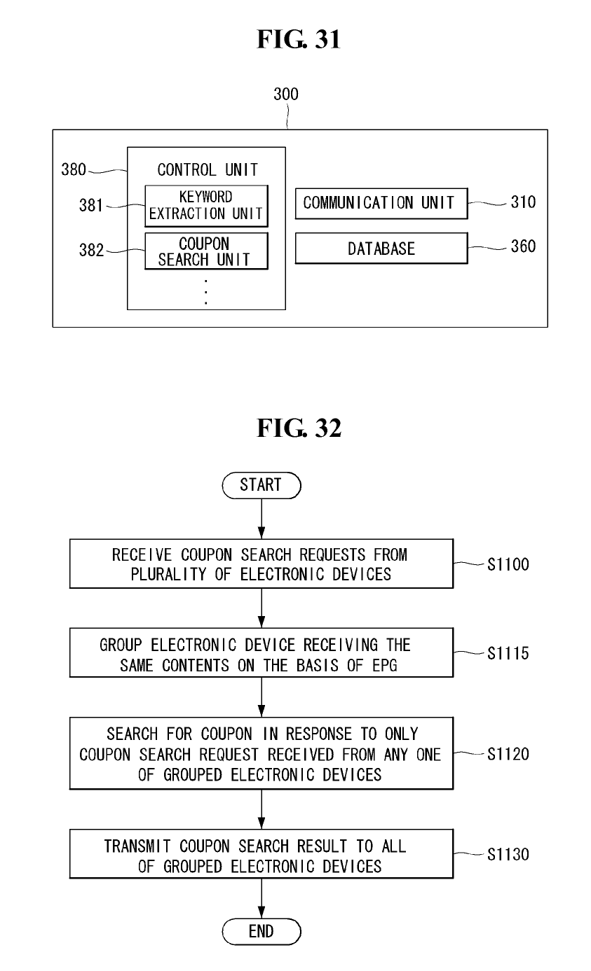

FIG. 31 is a block diagram of a social commerce server 300 according to the present invention. The social commerce server 300 may perform coupon search in response to a coupon search request from an external electronic device, which is received through a communication unit 310, and send a result of the coupon search to the external electronic device.

Referring to FIG. 31, the social commerce server 300 includes the communication unit 310, a database 360, a control unit 380. The communication unit 310 may perform communication with the external electronic device. The database 360 stores coupon-related information regarding various products.

The control unit 380 controls the overall operation of the social commerce server 300. Meanwhile, when requests for coupon search is received from a plurality of electronic devices receiving the same contents, the control unit 380 may perform coupon search in response to only a coupon search request received from one of the plurality of electronic devices, and send a result of the coupon search to all of the plurality of electronic devices including the one electronic device.

Therefore, in the social commerce server 300, overload which may occur due to the concurrent requests for coupon search and coupon search can be obviated, the efficiency in using resources can be improved, power consumption can be reduced, and the coupon search can be performed quickly.

The control unit 380 includes a keyword extraction unit 381 and a coupon search unit 382. The keyword extraction unit 381 may extract a search keyword for coupon search on the basis of an image, a word and the like received from the external electronic device. According to another implementation example of the present invention, the search keyword may be received from the external electronic device.

The coupon search unit 382 may search the database for coupon-related information regarding a product corresponding to the extracted search keyword, and send the searched information to the external electronic device through the communication unit 310.

FIG. 32 is a flowchart illustrating one example of a coupon search method performed in the social commerce server 300 according to the present invention.

Requests for coupon search are received from a plurality of electronic devices in operation S1100. When the coupon search results are received, the control unit 380 of the social commerce server 310 groups electronic devices receiving the same contents among the plurality of electronic devices, on the basis of an EPG for each of the plurality of electronic devices in operation S1115. At this time, the EPG for each electronic device may be included in the coupon search request, or may be received from each electronic device separately from the coupon search request.

Subsequently, the control unit 380 performs coupon search in response to only a coupon search request received from any one of the grouped electronic devices in operation S1120. When the coupon search is completed, the control unit 380 sends a result of the coupon search to all of the grouped electronic devices in operation S1130.

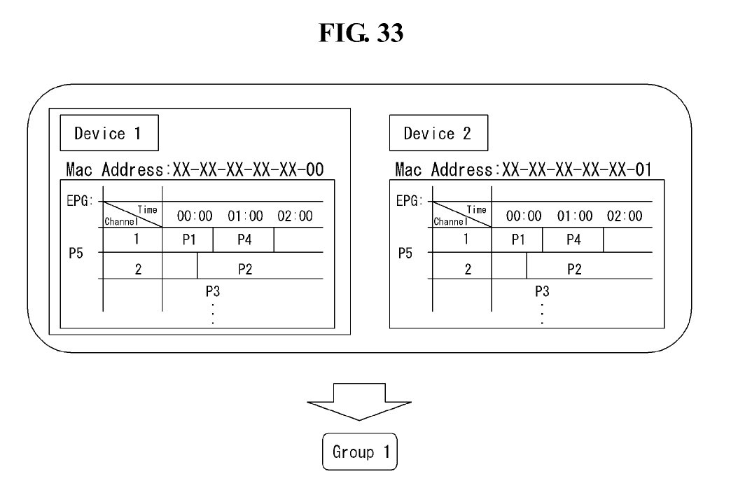

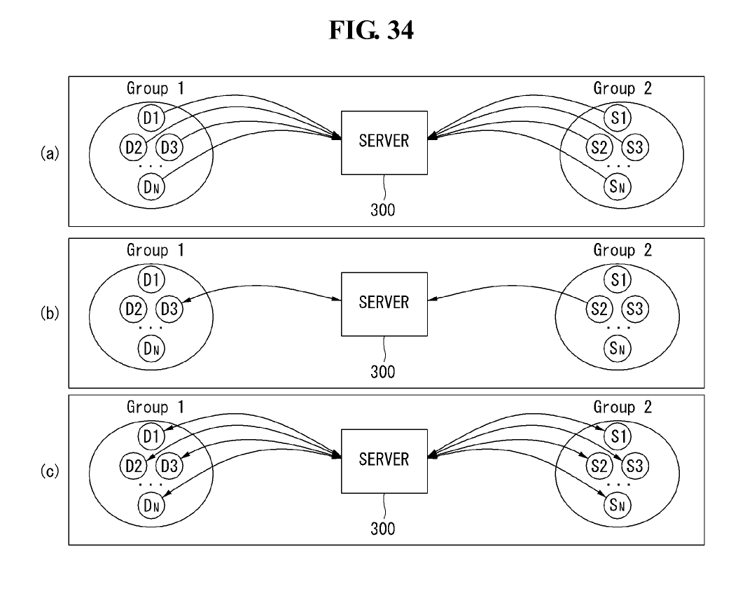

FIGS. 33 and 34 illustrate the process of executing the coupon search method shown in FIG. 32.

Referring to FIG. 33, since EPGs received from a first electronic device Device 1 and a second electronic device Device 2 are identical to each other, the control unit 380 may set the first electronic device Device 1 and the second electronic device Device 2 as a single group Group 1.

Referring to FIG. 34A, a plurality of external devices are connected to the social commerce server 300, and the plurality of external devices are grouped into a first group Group 1 and a second group Group 2 each of which is receiving the same contents.

Referring to FIG. 34B, the social commerce server 300 sets representative electronic devices D3 and S2 from the first group Group 1 and the second group Group 2, respectively, and performs coupon search in response to coupon search requests received from the representative electronic devices D3 and S2.

Thereafter, as shown in FIG. 34C, the social commerce server 300 transmits a result of the coupon search performed in response to the coupon search request of the first representative electronic device D3 to the electronic devices included in the first group Group 1, and transmits a result of the coupon search performed in response to the coupon search request of the second representative electronic device S2 to the electronic devices included in the second group Group 2.

As set forth above, according to the embodiments of the present invention, the electronic device can extract a search keyword from received contents, and then search for a coupon by using the extracted search keyword.

Also, the electronic device can share a coupon search result with another electronic device.

Furthermore, according to the type of contents being output, the electronic device can search for a coupon by extracting a search factor from the contents being output or can perform coupon search on the basis of information regarding contents which are to be output after the contents currently being output.

Also, the electronic device can allow a coupon selected from among searched coupons to be used to order a product corresponding to the selected coupon or can transmit the selected coupon to another electronic device.

Also, when requests for coupon search are received from a plurality of electronic devices receiving the same contents, the social commerce server according to the embodiment of the present invention can perform coupon search in response to only a coupon search request from one of the plurality of electronic devices, and send a result of the search to the plurality of electronic devices including the one electronic device.

According to the embodiments of the present invention, there are provided an electronic device and a social commerce server capable of performing coupon search on the basis of a search factor extracted from contents

The above described coupon search methods of the electronic device 100 according to the present invention can be written as computer programs and can be implemented in digital computers that execute the programs using a computer readable recording medium. The data processing method in a mobile terminal with a touch screen according to embodiments of the present invention can be executed through software. The software can include code segments that perform required tasks. Programs or code segments can also be stored in a processor readable medium and transmitted.

The computer readable recording medium includes all types of recording devices storing data readable by computer systems. Examples of the computer readable recording medium include ROM, RAM, CD-ROM, DVD±ROM, DVD-RAM, magnetic tapes, floppy disks, hard disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electronic device comprising:
a communication unit configured to receive content from an external source; and
a control unit configured to:
control output of the received content on an output unit;
analyze the received content that is output for search keywords;
extract a search keyword from the received content based on the analysis of the received content that is output;
access a social commerce network;
initiate, on the accessed social commerce network, a coupon search for a coupon for a product that relates to the search keyword;
access a result of the coupon search on the accessed social commerce network;
identify a target electronic device arranged to receive a result of the coupon search, the target electronic device being different from the electronic device; and
transmit the accessed result of the coupon search to the target electronic device based on the identification of the target electronic device.

2. The electronic device of claim 1, further comprising the output unit on which the received content is output,
wherein the control unit is configured to extract the search keyword from the received content based on analysis of at least one of:
an image of a video signal of the content output through the output unit, and
a parsed word from a sound signal output through the output unit.

3. The electronic device of claim 2, further comprising a memory configured to store product information as a thesaurus,
wherein the control unit is configured to extract the search keyword by comparing the product information from the thesaurus with a parsed word from a sound signal output through the output unit.

4. The electronic device of claim 2, wherein the control unit is configured to request extraction of the search keyword by transmitting at least one of the image and the parsed word to the social commerce network.

5. The electronic device of claim 1, wherein the control unit is configured to search for a product corresponding to the search keyword in the social commerce network, and then search for a coupon for the searched product.

6. The electronic device of claim 1, wherein the control unit is configured to extract a watermark included in a video signal or an audio signal of the received content, and extract the search keyword based on the extracted watermark.

7. The electronic device of claim 1, further comprising a display configured to output a video signal of the received content,
wherein the control unit is configured to:
identify a plurality of predetermined spots of the display;
access video information that corresponds to the identified plurality of predetermined spots of the display; and
extract the search keyword based on a combination of the accessed video information that corresponds to the identified plurality of predetermined spots of the display.

8. The electronic device of claim 1, wherein the control unit is configured to:
identify a predetermined specific region relevant to the coupon search; and
initiate the coupon search for a coupon associated with the predetermined specific region.

9. The electronic device of claim 1, further comprising a display configured to display a social commerce site issuing the result of the coupon search,
wherein the control unit is configured to:
receive a selection of the social commerce site displayed on the display;
based on the selection of the social commerce site displayed on the display, display information related to the result of the coupon search;
receive a selection of the information related to the result of the coupon search displayed on the display; and
based on the selection of the information related to the result of the coupon search displayed on the display, transmit information related to the searched coupon to the target electronic device.

10. The electronic device of claim 1, wherein the control unit is configured to control the social commerce network to transmit the result of the coupon search to another predetermined electronic device.

11. The electronic device of claim 1, wherein the control unit is configured to receive the result of the coupon search through the communication unit, and transmit, through the communication unit, the received result of the coupon search to the target electronic device over a short range wireless communication network.

12. The electronic device of claim 1, wherein the control unit is configured to receive the result of the coupon search through the communication unit, and transmit the received result of the coupon search to a remote controller that is configured to control the electronic device, and
wherein the remote controller is configured to:
recognize that the target electronic device is within an effective communication distance of a short range wireless communication network used by the remote controller; and
transmit the result of the coupon search to the target electronic device based on the recognition that the target electronic device is within the effective communication distance of the short range wireless communication network used by the remote controller.

13. An electronic device comprising:
a communication unit configured to receive content; and
a control unit configured to:
control output of first content received by the communication unit;
during output of the first content:
access content schedule data that indicates a schedule of content to be output;
based on the accessed content schedule data, determine second content scheduled to be output after the first content, the second content being a different type of content than the first content; and
initiate, while the first content is being output, performance of a coupon search based on the second content that is scheduled to be output after the first content.

14. The electronic device of claim 13, wherein the communication unit is configured to receive additional content information through the communication unit, and
the control unit is configured to access the content schedule data based on the received additional content information.

15. The electronic device of claim 13, further comprising a memory configured to store a result of the coupon search based on the second content that is scheduled to be output after the first content,
wherein the control unit is configured to output the stored result of the coupon search while the second content is output through the output unit.

16. The electronic device of claim 13, wherein the control unit is configured to:
identify a type of the first content;
determine whether the identified type of the first content is a type of content used in performing coupon searches;
based on a determination that the identified type of the first content is a type of content used in performing coupon searches, initiate, while the first content is being output, performance of the coupon search based on the first content; and
based on a determination that the identified type of the first content is not a type of content used in performing coupon searches, initiate, while the first content is being output, performance of the coupon search based on the second content that is scheduled to be output after the first content.

17. An electronic device comprising:
a communication unit configured to receive content from an external source; and
a control unit configured to:
extract a search factor from content received through the communication unit;
initiate a coupon search for a coupon for a product that relates the search factor;
access a result of the coupon search, the result of the coupon search being a list of coupons identified as potential matches in the coupon search;
control display, on a display, of the list of coupons identified as potential matches in the coupon search;
receive selection of a specific coupon from among the displayed list of coupons;
based on the selection of the specific coupon, control display, on the display, of a user interface that receives input for performing at least one of ordering a product corresponding to the specific coupon with the specific coupon applied thereto, and transmission of the specific coupon to another electronic device;
receive input provided through the user interface for performing at least one of ordering a product corresponding to the specific coupon with the specific coupon applied thereto, and transmission of the specific coupon to another electronic device; and
based on the received input provided through the user interface, perform at least one of ordering a product corresponding to the specific coupon with the specific coupon applied thereto, and transmission of the specific coupon to another electronic device.

18. The electronic device of claim 17, wherein the search factor includes at least one of a search keyword extracted from the received content, an image of a video signal of the received content being output through the display, and a word parsed from a sound signal of the received content.

19. The electronic device of claim 17, wherein the control unit is configured to:
identify a predetermined specific region relevant to the coupon search; and
initiate the coupon search for a coupon associated with the predetermined specific region.

20. The electronic device of claim 17, wherein the control unit is configured to determine the specific region in advance based on at least one of a location of the electronic device and a user's setting.

21. A social commerce server comprising:
a communication unit configured to receive, from a plurality of electronic devices, requests for coupon searches based on content being output by the plurality of electronic devices, each of the coupon searches being based on the same content being output by each of the plurality of electronic devices; and
a control unit configured to:
determine that the requests for coupon searches are based on the same content;
based on the determination that the requests for coupon searches are based on the same content, determine to use a same result to satisfy all of the coupon requests;
perform a single coupon search for the requests for coupon searches;
perform a single coupon search for the requests for coupon searches;
identify a result of the single coupon search based on performance of the single coupon search; and
transmit, through the communication unit, the identified result of the single coupon search to all of the plurality of electronic devices based on the determination to use the same result to satisfy all of the coupon requests.

22. The social commerce server of claim 21
wherein the control unit is configured to receive, through the communication unit, additional content information that is sent by the plurality of electronic devices and that describes content being output by the plurality of electronic devices; and
wherein the control unit is configured to determine that the requests for coupon searches are based on the same content by analyzing the additional content information received from the plurality of electronic devices.
